(19) United States
(12) Patent Application Publication
(10) Pub. No.: US 2015/0367626 A1
(43) Pub. Date: Dec. 24, 2015

(54) PASTE SUPPLY APPARATUS, SCREEN PRINTER, PASTE SUPPLY METHOD, AND SCREEN PRINTING METHOD

(71) Applicant: Panasonic Intellectual Property Management Co., Ltd., Osaka-shi, Osaka (JP)

(72) Inventors: Masayuki MANTANI, Yamanashi (JP); Hiroki KOBAYASHI, Yamanashi (JP); Hideaki MORI, Yamanashi (JP); Michinori TOMOMATSU, Yamanashi (JP)

(21) Appl. No.: 14/765,155

(22) PCT Filed: Feb. 4, 2014
(86) PCT No.: PCT/JP2014/000599

§ 371 Date: Jul. 31, 2015

(30) Foreign Application Priority Data
Feb. 7, 2013 (JP) 2013-021892

(51) Int. Cl. B41F 15/44

(52) U.S. Cl. CPC B41F 15/44

(57) ABSTRACT

A screen printer includes: a mask; a paste supply apparatus which supplies paste to the mask contacting a board; and a squeegee. The paste supply apparatus includes: a paste pot which is a disposable and consumable part, and which includes a bottomed cylindrical member which stores the paste, and an inner lid movably inserted into the cylindrical member and having a through hole formed in a center portion of the inner lid; a pot holding portion which holds the paste pot in a posture in which the through hole faces downward; and a paste extruding portion which moves the cylindrical member relative to the inner lid of the paste pot held by the pot holding portion and extrudes the paste from the through hole. The paste pot is disposed of after the paste is used up.

### TECHNICAL FIELD

The present invention relates to a paste supply apparatus, a screen printer, a paste supply method and a screen printing method, in which paste is supplied to a mask brought into contact with a board in the screen printer.

### BACKGROUND ART

As a background-art paste supply apparatus for supplying paste to a mask which contacts a board in a screen printer, there has been known an apparatus in which paste extruded from a syringe storing the paste is supplied to the mask (for example, Patent Document 1). The paste to be stored in a syringe is delivered in the state where the paste has been enclosed in a so-called paste pot which is an airtight container including a bottomed cylindrical member and an inner lid inserted into the cylindrical member. There has been also known a paste supply apparatus which does not transfer the paste from the paste pot to the syringe but uses the paste pot itself as the syringe (for example, Patent Document 2).

In the latter of the above-described paste supply apparatus, for advance preparation, the inner lid is removed from the cylindrical member of the paste pot and a circular packing with a nozzle is inserted into the cylindrical member. The paste pot is then attached to a pot holding portion and held in a posture in which an end portion of the nozzle faces downward, and the packing is fixed to the pot holding portion. In this state, the cylindrical member is pushed downward (that is, the cylindrical member is moved relative to the packing) to extrude the paste from the nozzle. In this manner, it is not necessary to perform an operation for transferring the paste from the paste pot to a syringe, and working efficiency in screen printing can be improved.

### RELATED ART DOCUMENTS

### Patent Documents

Patent Document 1: JP-A-2011-140176

Patent Document 2: JP-A-2010-172928

### SUMMARY OF THE INVENTION

### Problem to be Solved by the Invention

According to the above-described apparatus, however, the manufacturing cost for the packing with a nozzle as an additional part added to a paste pot to be delivered is required. In addition, it is necessary to perform working for reuse of the additional part, such as removing the packing with a nozzle from a used paste pot, cleaning the packing, and attaching the packing to a new paste pot. Thus, there has been a problem that the working efficiency is not good.

An object of the invention to provide a paste supply apparatus, a screen printer, a paste supply method and a screen printing method, in which the cost can be reduced and working can be simplified.

### Means for Solving the Problem

A paste supply apparatus of the invention includes: a paste pot including a bottomed cylindrical member which stores paste, and an inner lid which is movably inserted into the cylindrical member and in which a through hole is formed in a center portion of the inner lid; a pot holding portion which holds the paste pot in a posture in which the through hole faces downward; and a paste extruding portion which moves the cylindrical member relative to the inner lid of the paste pot held by the pot holding portion and extrudes the paste from the through hole.

A screen printer of the invention includes: a mask which is brought into contact with a board; a paste supply apparatus according to claim 1, which extrudes and supplies the paste to the mask contacting the board; and a squeegee which slides on the mask to which the paste has been supplied by the paste supply apparatus.

A paste supply method of the invention includes: a pot holding step of holding a paste pot including a bottomed cylindrical portion storing paste and an inner lid movably inserted into the cylindrical member and having a through hole formed in a center portion of the inner lid in a posture in which the through hole faces downward; and a paste extruding step of moving the cylindrical member relative to the inner lid of the paste pot held in the posture in which the through hole faces downward, and extruding the paste from the through hole.

A screen printing method of the invention includes: a contact step of bringing a board and a mask into contact with each other; a paste supply step of extruding and supplying paste from a paste supply apparatus according to claim 1 to the mask contacting the board; and a squeegee slide step of sliding a squeegee on the mask to which the paste has been supplied.

### Advantages of the Invention

In the invention, the paste pot is held in a posture in which the through hole of the inner lid faces downward, and the cylindrical member is then moved relative to the inner lid to extrude the paste from the through hole and supply the paste. Accordingly, it is not necessary to prepare any additional part such as a packing with a nozzle as in the background-art, and it is possible to reduce the cost. In addition, it is not necessary to reuse such an additional part, and it is possible to simplify working.

### BRIEF DESCRIPTION OF THE DRAWINGS

FIG. 1 is a side view of a screen printer according to an embodiment of the invention.

FIG. 2 is a plan view of the screen printer according to the embodiment of the invention.

FIG. 3 is a perspective view of a paste supply apparatus provided in the screen printer according to the embodiment of the invention.

FIG. 4 is a partially exploded view of the paste supply apparatus according to the embodiment of the invention.

FIGS. 5(a), 5(b), 5(c) and 5(d) are perspective views of a paste pot for use in the paste supply apparatus according to the embodiment of the invention.

FIGS. 6(a) and 6(b) are perspective views of the paste supply apparatus according to the embodiment of the invention.

FIGS. 7(a) and 7(b) are perspective views of the paste supply apparatus according to the embodiment of the invention.

FIGS. 8(a) and 8(b) are perspective views of the paste supply apparatus according to the embodiment of the invention.

FIGS. 9(a) and 9(b) are partially enlarged views of the screen printer according to the embodiment of the invention.

FIG. 10 is a block diagram showing a control system of the screen printer according to the embodiment of the invention.

FIG. 11 is a side view of the screen printer according to the embodiment of the invention.

### MODE FOR CARRYING OUT THE INVENTION

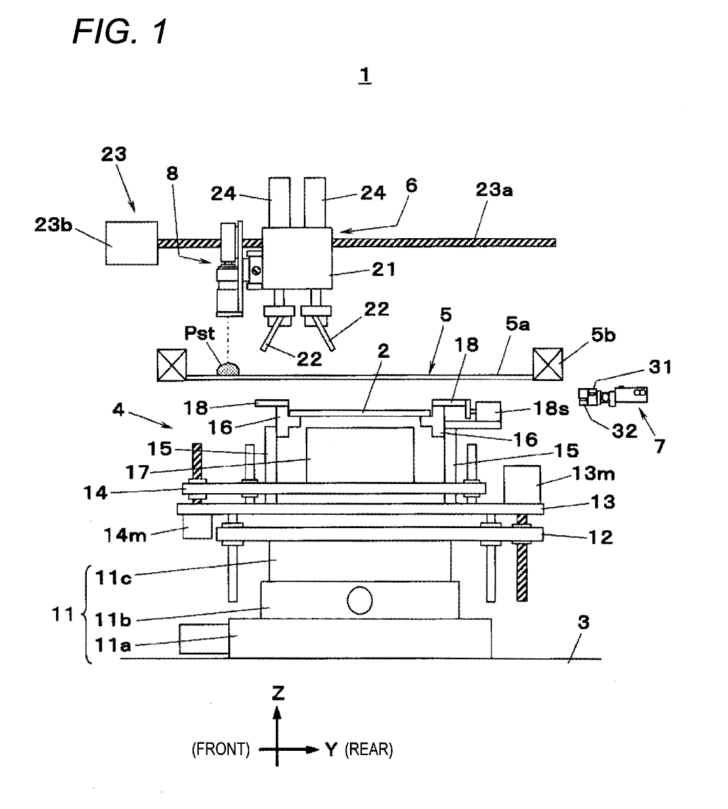

An embodiment of the invention will be described below with reference to the drawings. A screen printer 1 shown in FIG. 1 is an apparatus for repeatedly executing screen printing with paste Pst such as solder paste on a board 2. The screen printer 1 has a board holding/moving unit 4 provided on a base 3 to hold and move the board 2, a mask 5 placed in a horizontal posture above the board holding/moving unit 4, a squeegee unit 6 provided above the mask 5, a camera unit 7 provided under the mask 5, and a paste supply apparatus 8 provided above the mask 5 and integrally with the squeegee unit 6.

In FIG. 1, the board holding/moving unit 4 has a configuration in which a first lifting table 13 and a second lifting table 14 are provided in this order from bottom and above a base table 12 that can be moved within a horizontal plane and rotated around a vertical axis by an XYθ moving mechanism 11 provided on the base 3.

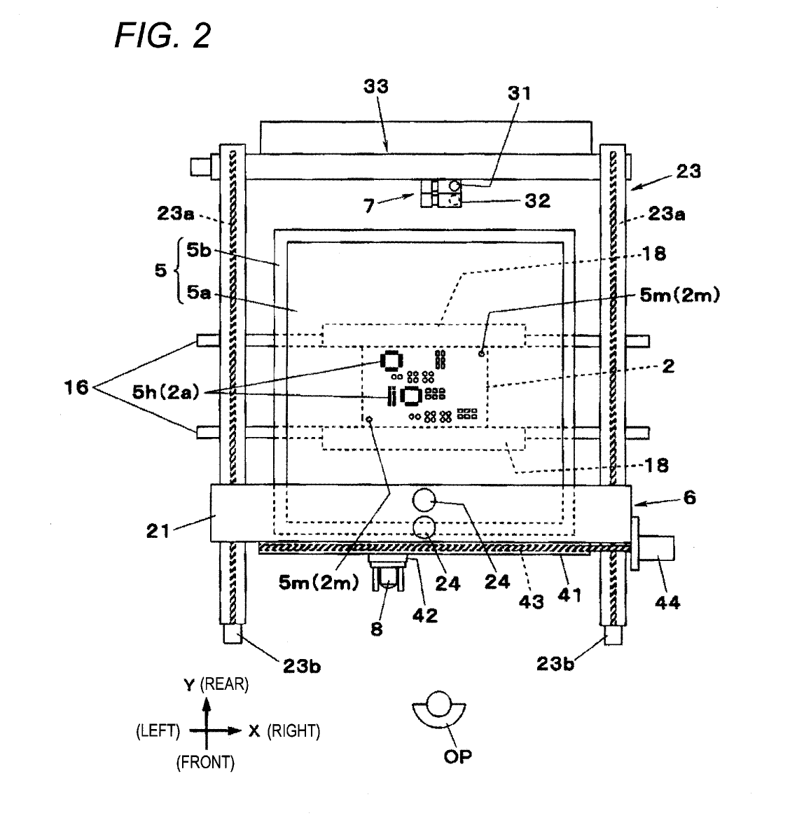

The XYθ moving mechanism 11 includes a stack of a Y-axis table 11a, an X-axis table 11b and a θ table 11c. The Y-axis table 11a extends in a Y-axis direction (which is a front/rear direction observed from an operator OP shown in FIG. 2, and a left/right direction of the sheet of FIG. 1) on the base 3. The X-axis table 11b is provided to extend in an X-axis direction (which is a left/right direction observed from the operator OP, and a direction perpendicular to the sheet of FIG. 1) on the Y-axis table 11a. The θ table 11c is provided on the X-axis table 11b. The X-axis table 11b is moved on the Y-axis table 11a and in the Y-axis direction when the Y-axis table 11a is driven. The θ table 11c is moved on the X-axis table 11c and in the X-axis direction when the X-axis table 11b is driven. The base table 12 is rotated around the vertical axis of the sheet of FIG. 1 (referred to as Z-axis direction) when the θ table 11c is driven. That is, the base table 12 is moved within a horizontal plane by the XYθ moving mechanism 11. The first lifting table 13 is moved up/down relative to the base table 12 by a first lifting table lifting motor 13m. The second lifting table 14 is moved up/down relative to the first lifting table 13 by a second lifting table lifting motor 14m.

A pair of conveyor support members 15 are provided to extend upward from the first lifting table 13 and penetrate the second lifting table 14. A pair of carrying conveyors 16 disposed to extend in the X-axis direction and to be opposed to each other in the Y-axis direction are supported by the paired conveyor support members 15. The paired carrying conveyors 16 support opposite end portions of the board 2 from below and convey the board 2 in the X-axis direction. A lower receiving member 17 is provided on the top surface of the second lifting table 14.

Above the paired carrying conveyors 16, a pair of clamp members (clampers 18) are provided to extend in the Y-axis direction and disposed to be opposed to each other in the X-axis direction. The paired clampers 18 are opened/closed in the Y-axis direction by operation of a damper opening/closing cylinder 18s so that the opposite end portions of the board 2 on the carrying conveyors 16 can be held (clamped) between the paired clampers 18.

In FIG. 2, the mask 5 includes a plate portion 5a having a flat plate-like shape and extending to spread in the XY plane and a frame portion 5b holding the outer circumference of the plate portion 5a. Pattern holes 5h corresponding to electrodes 2a on the board 2 are provided within a rectangular region of the plate portion 5a surrounded by the frame portion 5b.

In FIG. 2, two board-side marks 2m are paired and provided in diagonal positions of the board 2, and two mask-side marks 5m disposed correspondingly to the board-side marks 2m are paired and provided in the plate portion 5a of the mask 5. When the board 2 is brought into contact with the mask 5 so that the board-side marks 2m can align with the mask-side marks 5m in planar view, the electrodes 2a of the board 2 can be aligned with the pattern holes 5h of the mask 5.

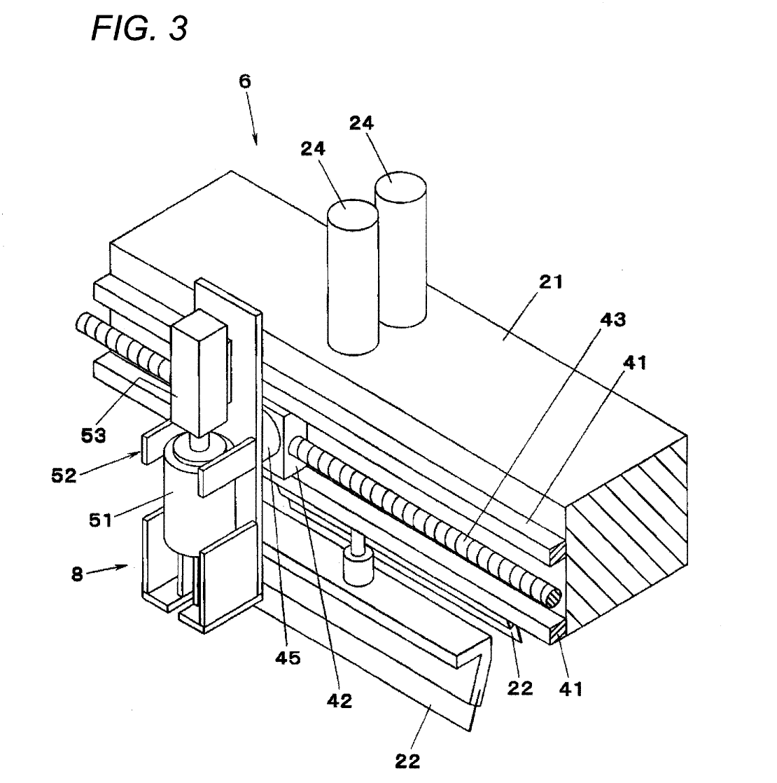

In FIG. 1, FIG. 2 and FIG. 3, the squeegee unit 6 includes two squeegees 22 disposed to be opposed to each other in the Y-axis direction under a squeegee base 21 provided to extend in the X-axis direction. The squeegee base 21 is moved in the Y-axis direction by a squeegee unit moving mechanism 23. The squeegee unit moving mechanism 23 includes a pair of squeegee unit moving ball screws 23a disposed to be opposed to each other in the X-axis direction and extending in the Y-axis direction above the mask 5, and two squeegee unit moving motors 23b rotationally driving the squeegee unit moving ball screws 23a respectively. The squeegee unit moving ball screws 23a are screwed into left and right end portions of the squeegee base 21 so as to penetrate the left and right end portions, respectively. Thus, when the paired squeegee unit moving ball screws 23a are rotated forward and backward in sync with each other by the two squeegee unit moving motors 23b respectively, the squeegee base 21 moves in the Y-axis direction in accordance therewith. The two squeegees 22 are moved up/down relative to the squeegee base 21 individually by squeegee lifting cylinders 24 provided in the squeegee base 21.

In FIG. 1 and FIG. 2, the camera unit 7 includes an upward imaging camera 31 whose imaging visual field is directed upward and a downward imaging camera 32 whose imaging visual field is directed downward. The camera unit 7 is moved within a horizontal plane by a camera unit moving mechanism 33.

FIG. 1 and FIG. 2, the paste supply apparatus 8 is provided on the front surface side of the squeegee base 21 so as to extrude and supply the pastes Pst to the mask 5 brought into contact with the board 2. In FIG. 3, a pair of guide members 41 extending in the X-axis direction are disposed vertically on the front surface of the squeegee base 21, and a ball screw 43 extending in the X-axis direction is screwed into a block member 42 guided by the paired guide members 41, so as to penetrate the block member 42. The ball screw 43 can be rotated desirably by a paste supply apparatus moving motor 44 provided in an end portion of the squeegee base 21. When the ball screw 43 is rotated forward/backward by the paste supply apparatus moving motor 44, the block member 42 can be moved in the X-axis direction. The paste supply apparatus 8 is attached to the block member 42 through a posture changing motor 45.

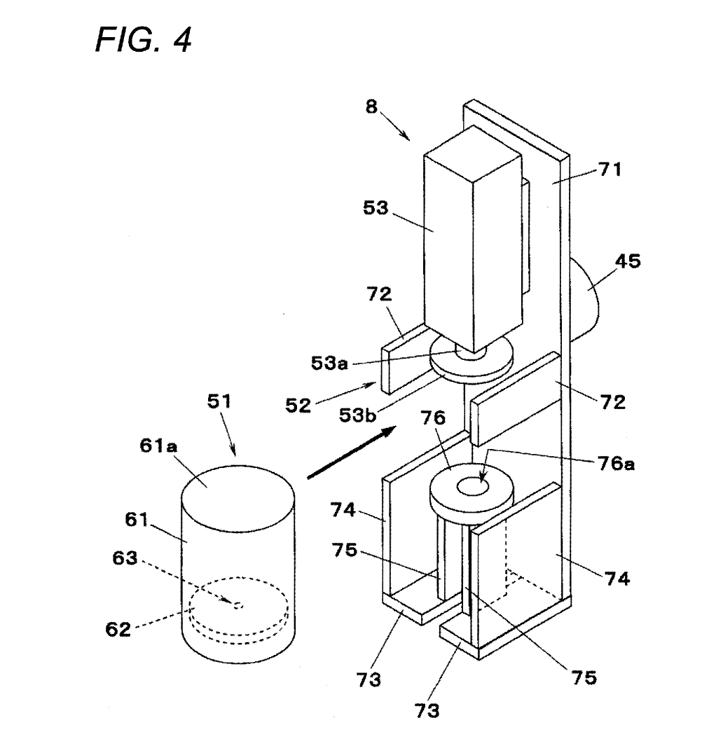

In FIG. 3 and FIG. 4, the paste supply apparatus 8 includes a paste pot 51 that stores the paste Pst, a pot holding portion 52 that holds the paste pot 51, a pot pressing cylinder 53 that presses the paste pot 51 held by the pot holding portion 52.

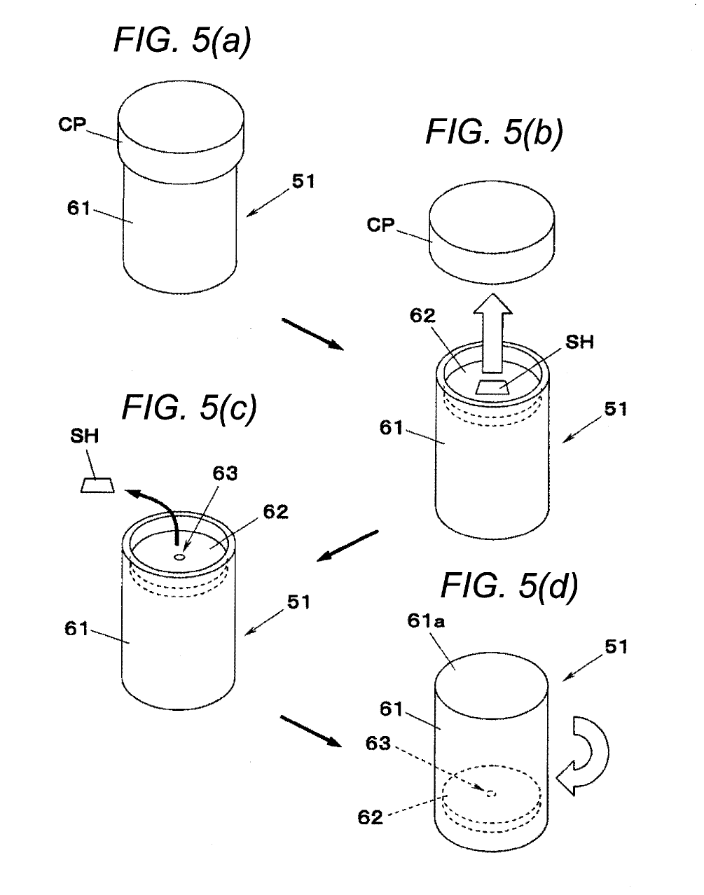

The base pot 51 has a configuration in which an inner lid 62 is movably inserted into a bottomed cylindrical member 61 storing the paste Pst, and a through hole 63 is formed in a center portion of the inner lid 62. Before the paste pot 51 is used, a cap CP attached to an opening-side end portion of the paste pot 51 is removed (FIG. 5(a) to FIG. 5(b)). An adhesive sheet SH sealing the through hole 63 is separated from the inner lid 62 (FIG. 5(c)). Then the paste pot 51 is turned upside down into a posture in which the through hole 63 faces downward (FIG. 5(d)).

In FIG. 4, the pot holding portion 52 includes a plate-like base portion 71 attached to the posture changing motor 45 so as to extend in the up/down direction, left and right intermediate support portions 72 provided to protrude to the front from a vertically intermediate portion of the base portion 71, left and right lower extension portions 73 provided to extend to the front from a lower portion of the base portion 71, left and right lower support portions 74 provided to extend upward from left/right direction outside end portions of the lower extension portions 73 respectively, left and right inner lid support portion columns 75 provided to extend upward from left/right direction inside end portions of the lower extension portions 73 respectively, and a ring-like inner lid support portion 76 attached to the upper ends of the left and right inner lid support portion columns 75 and having, at the center thereof, a hole 76a whose inner diameter is larger than the through hole 63 of the paste pot 51.

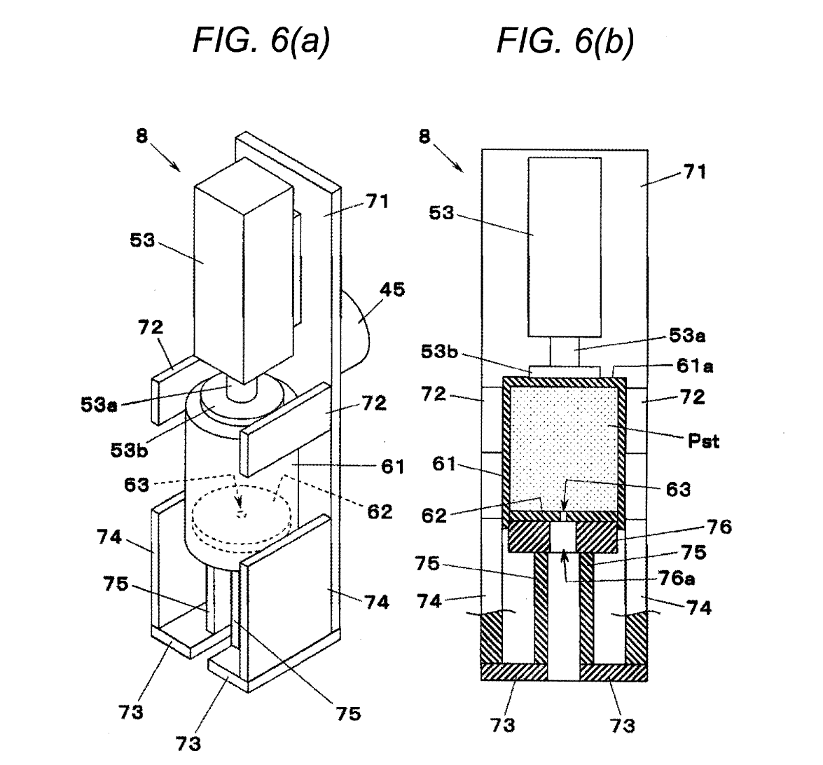

A larger distance than the outer diameter of the cylindrical member 61 of the paste pot 51 is provided between the left and right intermediate support portions 72 and between the left and right lower support portions 74, so that the paste pot 51 with the through hole 63 facing downward can be supported movably (slidably) in the up/down direction by the left and right intermediate support portions 72 and the left and right lower support portions 74 (FIGS. 6(a) and 6(b)). When the paste pot 51 supported by the left and right intermediate support portions 72 and the left and right lower support portions 74 is moved downward, the inner lid 62 abuts against the inner lid support portion 76 from above. In this state, the through hole 63 of the inner lid 62 and the hole 76a of the inner lid support portion 76 are located coaxially. The pot pressing cylinder 53 is attached to an upper region of the base portion 71 so that a piston rod 53a can face downward. A pad member 53b is attached to a lower end of the piston rod 53a.

A procedure (paste supply method) for supplying the paste Pst from the paste supply apparatus 8 will be described. An operator OP first sets the paste pot 51 so that the through hole 63 of the inner lid 62 can face downward, as described above. Next the operator OP attaches the paste pot 51 to the pot holding portion 52 so that the paste pot 51 can be moved up/down desirably by the left and right intermediate portions 72 and the left and right lower support portions 74 of the pot holding portion 52. The operator OP then pushes down the paste pot 51 with his/her finger so as to bring the inner lid 62 into contact with the inner lid supply portion 76 from above. Next the operator OP protrudes the piston rod 53a of the pot pressing cylinder 53 downward to press the pad member 53b against a bottom portion 61a of the cylindrical member 61 of the paste pot 51 and hold the paste pot 51 in the pot holding portion 52 (pot holding step). In this manner, according to the embodiment, the pot holding portion 52 holds the paste pot 51 in the posture in which the through hole 63 faces downward.

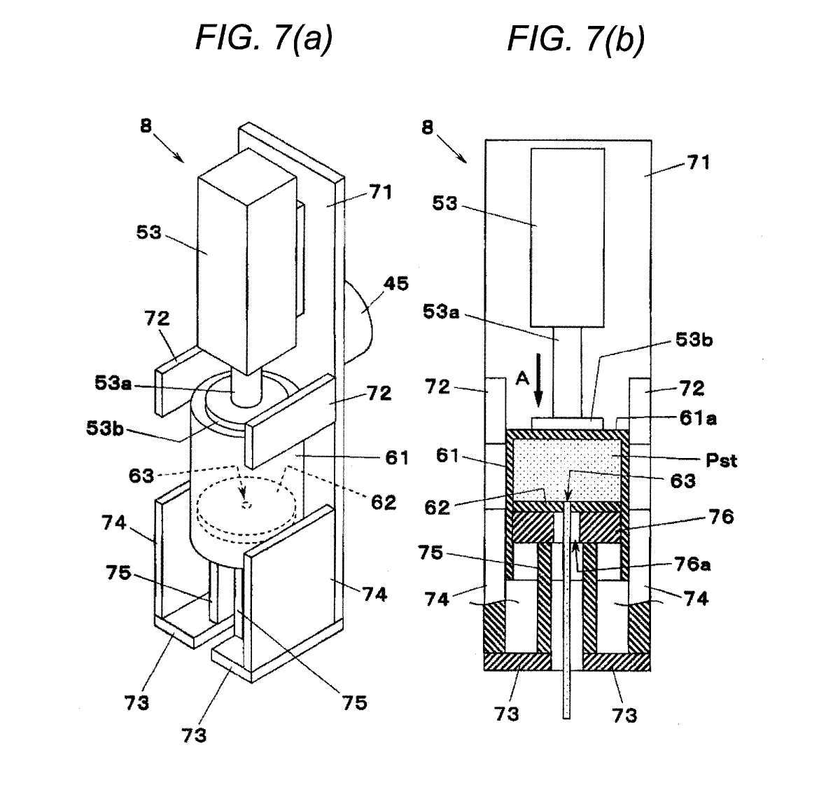

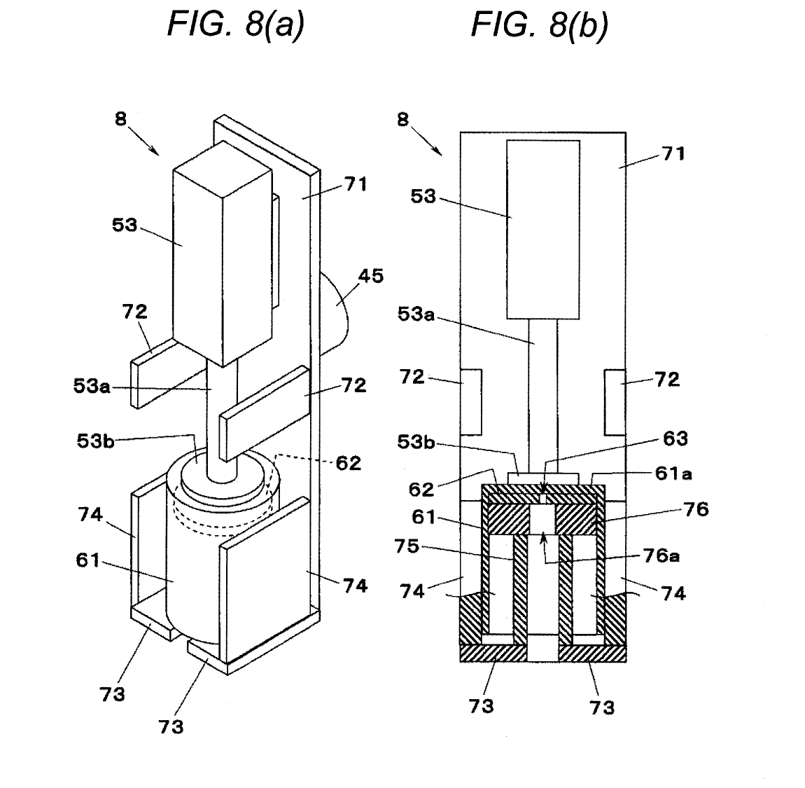

When the paste pot 51 is held in the pot holding portion 52 as described above, the paste Pst can be extruded from the paste supply apparatus 8. To extrude the paste Pst from the paste supply apparatus 8, the piston rod 53a is protruded downward (in the arrow A shown in FIG. 7(b)). Thus the cylindrical member 61 is pressed downward by the piston rod 53a so as to move downward relative to the inner lid 62 whose downward movement is restricted by the inner lid support portion 76 (FIGS. 6(a) and 6(b)→FIGS. 7(a) and 7(b)→FIGS. 8(a) and 8(b)), so that the paste Pst in the cylindrical member 61 can be extruded downward from the through hole 63 of the inner lid 62 (paste extruding step). The paste Pst extruded downward from the through hole 63 of the inner lid 62 is supplied to the lower part of the paste supply apparatus 8 through the hole 76a of the inner lid support portion 76 and through the space between the paired inner lid support portion columns 75 (FIGS. 7(a) and 7(b)). In this manner, according to the embodiment, the pot pressing cylinder 53 serves as a paste extruding portion to move the cylindrical member 61 relative to the inner lid 62 of the paste pot 51 held in the pot holding portion 52 to thereby extrude the paste Pst from the through hole 63.

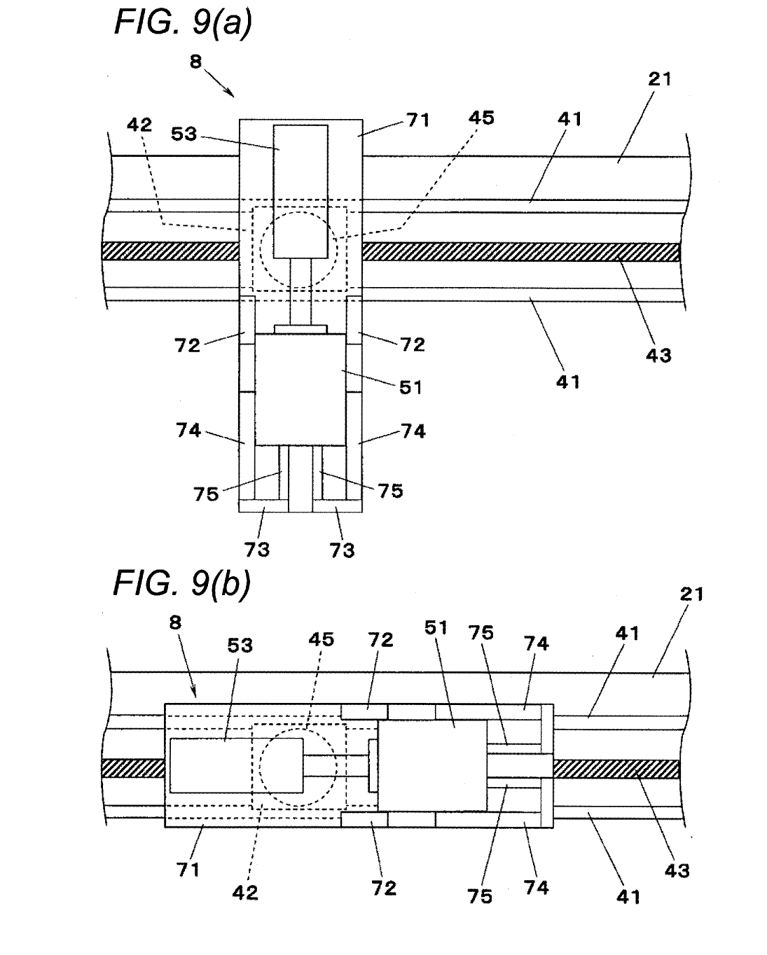

The paste supply apparatus 8 is rotated around the Y axis relative to the block member 42 by the operation of the posture changing motor 45. Thus, the posture of the paste supply apparatus 8 can be changed between a paste supply posture (FIG. 9(a)) in which the through hole 63 of the inner lid 62 of the paste pot 51 faces downward and a storage posture (FIG. 9(b)) rotating around the Y axis at an angle of 90 degrees from the paste supply posture. The paste supply apparatus 8 that has supplied the paste Pst is changed from the paste supply posture to the storage posture so that the paste Pst can be prevented from dripping after the paste Pst has been supplied. Incidentally, the paste pot 51 as a whole is a disposable and consumable part. After the paste Pst stored in the paste pot 51 has been used up from the cylindrical member 61, the paste pot 51 is removed from the pot holding portion 52 and disposed of as it is.

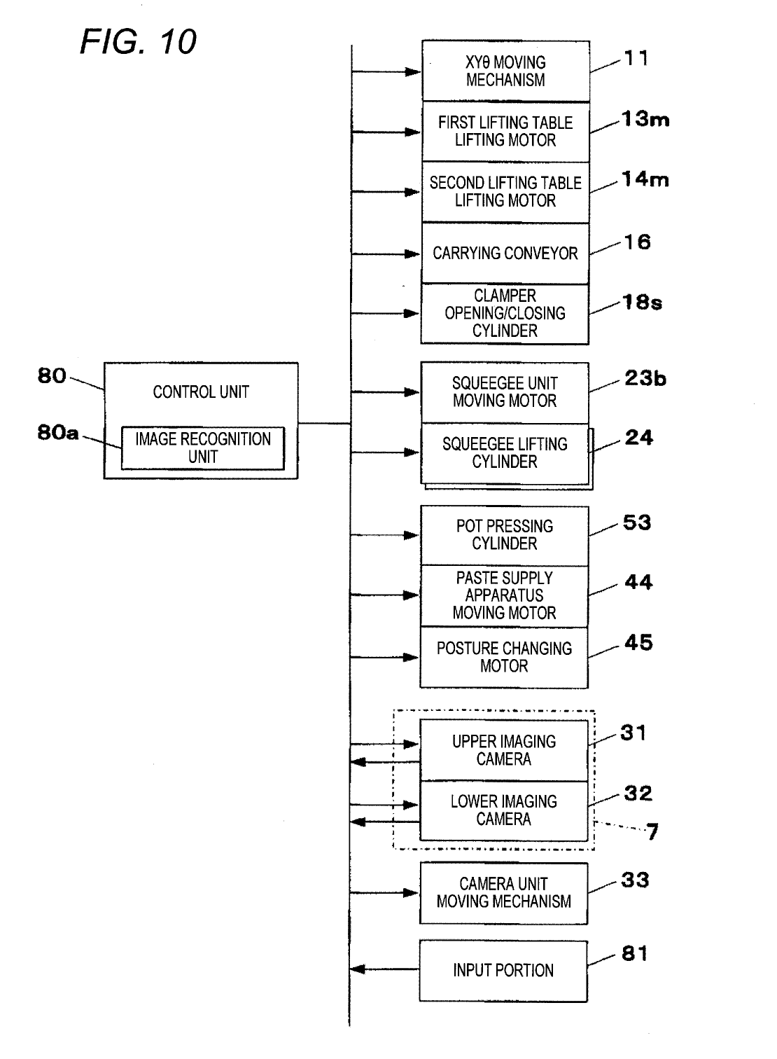

In the screen printer 1, a control unit 80 provided in the screen printer 1 controls an operation in which the board 2 is conveyed in the X-axis direction by the carrying conveyors 16 provided in the board holding/moving unit 4, an operation in which the second lifting table 14 is moved up/down by the second lifting table motor 14m (an operation in which the bottom surface of the board 2 is supported, as will be described later), an operation in which the board 2 is clamped by the clampers 18 opened/closed by the clamper opening/closing cylinder 18s, an operation in which the board 2 is moved within a horizontal plane by the XYθ moving mechanism 11, and an operation in which the first lifting table 13 is moved up/down by the first lifting table lifting motor 13m (an operation in which the clamped board 2 is moved up/down, as will be described later) (FIG. 10). In addition, the control unit 80 also controls an operation in which the squeegee unit 6 and the paste supply apparatus 8 are moved in the Y-axis direction by the squeegee unit moving motor 23b and an operation in which the squeegees 22 are moved up/down by the squeegee lifting cylinders 24 respectively (FIG. 10). Further, the control unit 80 also controls an operation in which the paste Pst is extruded from the paste pot 51 by the pot pressing cylinder 53, an operation in which the paste supply apparatus 8 is moved in the X-axis direction by the operation of the paste supply apparatus moving motor 44 and an operation in which the posture of the paste supply apparatus 8 is changed by the posture changing motor 45 (FIG. 10).

The control unit 80 controls an operation in which the camera unit 7 is moved within a horizontal plane by the camera unit moving mechanism 33, an operation in which an image is picked up by the upper imaging camera 31 provided in the camera unit 7 and an operation in which an image is picked up by the lower imaging camera 32 (FIG. 10). Image data obtained by the operation in which an image is picked up by the upper imaging camera 31 and image data obtained by the operation in which an image is picked up by the lower imaging camera 32 are inputted to the control unit 80 individually and subjected to image recognition processing in an image recognition unit 80a (FIG. 10).

Next, a procedure (screen printing method) for executing a screen printing operation in the screen printer 1 will be described. First, the operator OP performs a predetermined screen printing operation start operation through an input portion 81 (FIG. 10) connected to the control unit 80. On receiving the screen printing operation start operation, the control unit 80 receives the board 2 supplied from the outside of the screen printer 1, conveys the received board 2 on the carrying conveyors 16 and positions the board 2 in a lower working position between the paired clampers 18. Then the second lifting table 14 is moved up relative to the first lifting table 13 so that the bottom surface of the board 2 can be supported by the lower receiving member 17. After that, the second lifting table 14 is moved up to lift up the board 2 from the carrying conveyors 16. The opposite end portions of the board 2 are clamped and held in the Y-axis direction by the paired clampers 18.

When the board 2 is clamped, the control unit 80 moves the camera unit 7 into an area under the mask 5 and makes the lower imaging camera 32 pick up an image of the board-side marks 2m provided in the board 2 from above the board 2 so as to acquire image data of the board-side marks 2m. Next the control unit 80 makes the upper imaging camera 31 pick up an image of the mask-side marks 5m provided in the mask 5 from below the mask 5 so as to acquire image data of the mask-side marks 5m. Then the position of the board 2 is calculated by image recognition based on the acquired image data of the board-side marks 2m, and the position of the mask 5 is calculated by image recognition based on the image data of the mask-side marks 5m.

On calculating the position of the board 2 and the position of the mask 5, the control unit 80 moves the camera unit 7 to a position out of the area under the mask 5. Then the control unit 80 controls the operation of the XYθ moving mechanism 11 to move the board 2 to thereby locate the board-side marks 2m just under the mask-side marks 5m. Thus, the board 2 can be aligned with the mask 5.

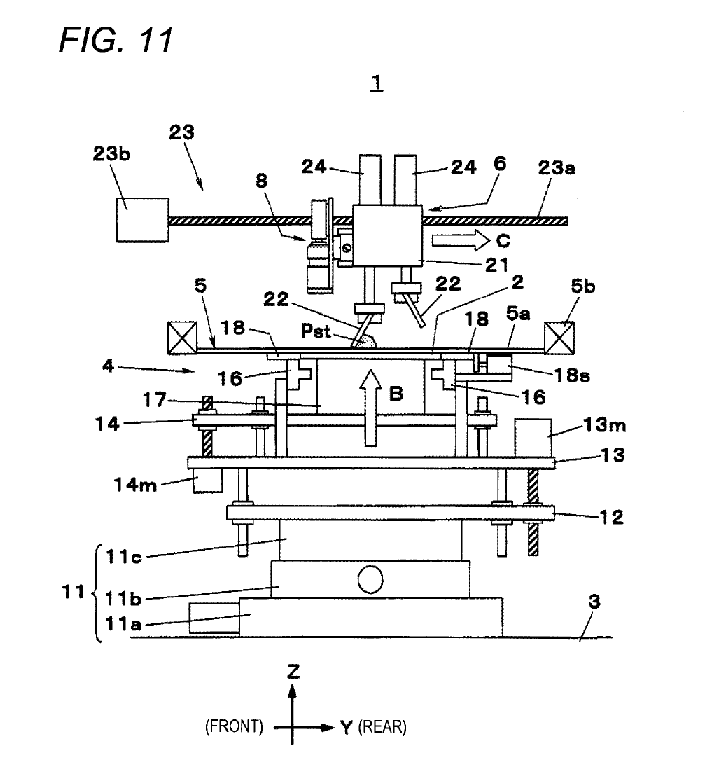

On aligning the board 2 with the mask 5, the control unit 80 moves up the first lifting table 13 of the board holding/moving unit 4 relative to the base table 12 (in the arrow B shown in FIG. 11). Thus, the electrodes 2a of the board 2 are aligned with the pattern holes 5h of the mask 5 so that the top surface of the board 2 and the top surfaces of the clampers 18 can be brought into contact with the bottom surface of the mask 5 (contact step).

On bringing the board 2 into contact with the mask 5, the control unit 80 moves the squeegee base 21 in the Y-axis direction so that the paste supply apparatus 8 in the paste supply posture can be moved to a predetermined position (normally a position above a part abutting against the dampers 18 in front of the mask 5). Then the control unit 80 operates the paste supply apparatus moving motor 44 to move the paste supply apparatus 8 in the X-axis direction while operating the pot pressing cylinder 53 to push the paste Pst from the paste pot 51 to thereby supply the paste Pst to the mask 5 (paste supply step).

On supplying the paste Pst to the mask 5, the control unit 80 moves down one of the squeegees 22 relative to the squeegee base 21 such that the lower end portion of the moved squeegee 22 contacts the mask 5, and moves the squeegee base 21 in the Y-axis direction (in the arrow C shown in FIG. 11) to slide the squeegee 22 on the mask 5 (squeegee slide step). Consequently, the paste Pst supplied to the mask 5 in advance is scraped by the squeegee 22, the paste Pst on the mask 5 is transferred to the electrodes 2a of the board 2.

During the above-described transfer of the paste Pst, the control unit 80 brings the squeegee 22 located in the front (on the left side of the sheet of FIG. 11) into contact with the mask 5 when the squeegee base 21 is moved from the front of the screen printer 1 to the rear of the same (from the left side of the sheet to the right side of the same in FIG. 11), and brings the squeegee 22 located at the rear (on the right side of the sheet of FIG. 11) into contact with the mask 5 when the squeegee base 21 is moved from the rear of the screen printer 1 to the front of the same (from the right side of the sheet to the left side of the same in FIG. 11).

When the operation of transferring the paste Pst is terminated, the control unit 80 moves down the first lifting table 13 to leave the board 2 from the mask 5 to thereby perform plate releasing. Further, the control unit 80 releases the board 2 from being held (clamped) by the paired clampers 18, and then moves down the second lifting table 14 to land the board 2 on the carrying conveyors 16. Then the control unit 80 operates the carrying conveyors 16 to convey the board 2 to the outside of the screen printer 1. Thus, the screen printing operation for one board 2 is terminated.

As has been described above, in the screen printer 1 and the screen printing method using the screen printer 1 (the paste supply apparatus 8 and the paste supply method using the paste supply apparatus 8) according to the embodiment, the paste pot 51 is held in a posture in which the through hole 63 of the inner lid 62 faces downward, and the cylindrical member 61 is then moved relative to the inner lid 62 so that the paste Pst extruded from the through hole 63 can be supplied. It is therefore unnecessary to provide any additional part such as a packing with a nozzle in the background art, but it is possible to reduce the cost. In addition, it is not necessary to reuse such an additional part, but it is also possible to simplify working. Thus, it is also possible to build an automatic paste pot exchanging mechanism to thereby enhance the working efficiency.

Incidentally, according to a modification, a tubular portion that is connected to the through hole 63 provided in the inner lid 62 and protruded in a direction to extrude the paste Pst may be formed in the inner lid 62. This is preferable because the paste Pst can be extruded more smoothly from the through hole 63.

The present application is based on a Japanese patent application (Japanese Patent Application No. 2013-021892) filed on Feb. 7, 2013, the contents of which are incorporated herein by reference.

### INDUSTRIAL APPLICABILITY

A paste supply apparatus, a screen printer, a paste supply method and a screen printing method which can reduce the cost and simplify working, are provided.

### DESCRIPTION OF REFERENCE SIGNS

1: Screen Printer
2: Board
5: Mask
8: Paste Supply Apparatus
22: Squeegee
51: Paste Pot
52: Pot Holding Portion
53: Pot Pressing Cylinder (Paste Extruding Portion)
61: Cylindrical Member
62: Inner Lid
63: Through Hole
Pst: Paste

1. (canceled)

2. A screen printer comprising:
a mask which is brought into contact with a board;
a paste supply apparatus which extrudes and supplies paste to the mask contacting the board; and
a squeegee which slides on the mask to which the paste has been supplied by the paste supply apparatus,
wherein the paste supply apparatus comprises:
a paste pot which is a disposable and consumable part, and which comprises a bottomed cylindrical member which stores the paste, and an inner lid which is movably inserted into the cylindrical member and in which a through hole is formed in a center portion of the inner lid;
a pot holding portion which holds the paste pot in a posture in which the through hole faces downward; and
a paste extruding portion which moves the cylindrical member relative to the inner lid of the paste pot held by the pot holding portion and extrudes the paste from the through hole, and
wherein the paste pot is disposed of after the paste is used up.

3. (canceled)

4. A screen printing method comprising:
bringing a board and a mask into contact with each other;
extruding and supplying paste from a paste supply apparatus to the mask contacting the board;
sliding a squeegee on the mask to which the paste has been supplied;
holding a paste pot which is a disposable and consumable part, and which comprises a bottomed cylindrical portion storing the paste and an inner lid movably inserted into the cylindrical member and having a through hole formed in a center portion of the inner lid in a posture in which the through hole faces downward;
moving the cylindrical member relative to the inner lid of the paste pot held in the posture in which the through hole faces downward, and extruding the paste from the through hole; and
disposing of the paste pot after the paste is used up.
